(19) United States
(12) Patent Application Publication
(10) Pub. No.: US 2014/0153754 A1
(43) Pub. Date: Jun. 5, 2014

(54) Otic sensory detection and protection system, device and method

(71) Applicants: Jacob Moesgaard, Coopenhagen (DK); Noah Kraft, New York, NY (US)

(72) Inventors: Jacob Moesgaard, Coopenhagen (DK); Noah Kraft, New York, NY (US)

(21) Appl. No.: 13/694,882

(22) Filed: Jan. 15, 2013

Related U.S. Application Data
(60) Provisional application No. 61/733,375, filed on Dec. 4, 2012.

(51) Int. Cl. H04R 25/00

(52) U.S. Cl. CPC H04R 25/00
USPC 381/312

(57) ABSTRACT

This invention relates generally to an otic sensory detection and protection system, device and method to monitor and identify potential hearing-damaging sound situations and generate data related audio information and/or modulation upon sensing of the hearing-damaging sound situation to reduce the damaging sound, its effect on the user and protect the user's hearing, either by the information or the modulation through applications, wristbands, mobile applications and other interfaces.

### COPYRIGHT NOTICE

A portion of the disclosure of this patent document contains material, which is or may be subject to copyright protection. The copyright owner has no objection to the facsimile reproduction by anyone of the patent document or the patent disclosure, as it appears in the Patent and Trademark Office patent file or records, but otherwise reserves all copyright whatsoever in all forms currently known or otherwise developed.

### BACKGROUND OF THE INVENTION

Dealing with noise and loud sounds, coupled with the current trend towards the use of personal sound producing devices and personal electronic devices (PEDs) that concentrate sound and often are played at decibel levels to exclude outside sounds, has caused hearing damage to many individuals at far earlier ages than previously reported. In common use are many types of miniature portable appliances, such as iPods®, smart phones and other personal listening devices, which through a helmet, a pair of headphones or ear buds, allow the user to listen to favorite audio content or programs anywhere and at anytime. Such PEDs have enjoyed great success for several years but they have the major disadvantage of acoustically isolating the user from the surrounding environment, particularly since a large number of users prefer to listen at a very high volume. Although perfect acoustic isolation allows for listening comfort, such isolation could subject the user to a wide range of hearing loss.

Hearing damage from common “social noise exposure” has been steadily increasing with noise coming from everyday social environments such as gyms, restaurants, fitness classes and bars. Noise in the street is often exacerbated by the proximity of buildings which tend to cause the sound to reverberate and surround an individual. Moreover, many individuals attend events which, by there very nature, are designed to expose the participants to loud noise as part of the entertainment value of the event. NASCAR racing, basketball tournaments, hockey and the like are but a few of the instances where the noise is often a critical part of the ambiance and experience, which the participant wants to enjoy.

Environmental noise and harmful exposure to it is steadily rising with the growth of populations and urban centers, the accessibility and popularity of personal music players (PMPs) and PEDs has changed the way many people, especially the younger population, obtains information, experiences audio and generally communicates. The prevalence of unregulated decibel levels at clubs, bars, concerts and restaurants has had a huge effect on hearing health today. In a European Commission-sponsored study in 2008, it was determined that most users listen to these devices at levels between 80 and 115 dB. Users will increase listening levels when background noise increases, especially with headphones that do not feature external noise cancellation. In all cases, a standard background noise of 80 dB (commonly encountered in urban environments) caused users to increase the volume on their devices to dangerous levels.

The advent of both higher noise levels and the creation of situations where individuals use sound to insulate themselves and hear what they want to hear at a decibel level that excludes otherwise intrusive sound has created a serious public health issue: hearing damage is becoming a major contemporary problem. Sensorineural hearing loss caused by noise exposure, be it a single traumatic noise event or exposure over a long period time, is called noise-induced hearing loss (NIHL). NIHL is steadily on the rise, and for the first time it represents the most common form of hearing loss across all demographics, with significant growth in youth populations. A MarkeTrack study indicates that hearing loss is up 33% over the past 25 years, with NIHL in adolescents age 14-19 up 30% since 1994 and hearing aid adoption rates—due to hearing loss—of 20- to 39-year olds grew faster than any other groups by far in 2010. While this problem is demonstrable, prevention, particularly in certain demographic age groups who are susceptible to such damage, is lacking and there is little effort being made to address the issue by minimizing the damaging noise or of otherwise attempting to reduce the hearing loss by reducing overexposure to noise.

The hearing aid market—while massive—still almost exclusively speaks to the elderly, as there is a massive stigma against adopting hearing aids across all demographics. There are many studies that indicate that once someone submits to buying a hearing aid they are by definition then considered to be “old.” Hearing loss and hearing research are huge fields and the development of hearing aids to assist persons with hearing loss achieve greater auditory information spans biomedical research, technology development, audio research, and social, occupational, and environmental research, but the use of hearing aids as prophylactic devises has not gained currency: the industry is still completely reaction, not proactive in the field of hearing health.

Noise-induced hearing loss (NIHL), a preventable form of hearing loss caused by overexposure to excessively loud noise that is effecting a new, younger demographic, and is causing hearing problems on an unprecedented scale. The American Hearing Research Foundation estimates that more than thirty million Americans are exposed to hazardous sound levels on a regular basis, while People Hearing Better (a leading online community for hearing health) indicates that hearing loss is now the third most common health problem in the nation, due mostly to noise exposure.

NIHL is a permanent hearing impairment. Anatomically, NIHL occurs when intense sound levels enter the ear and damage inner-ear hair cells that respond to sound and stimulate the cochlear nerve. Once damaged, these cells cannot be repaired. This type of hearing damage is becoming a major problem. The NIDCD estimates that twenty six million Americans between the ages of 12 and 69 (that is, not including the very elderly) suffer from some form of hearing loss due to noise damage.

Three factors affect NIHL: sound intensity, frequency, and duration. Sound intensity, measured in dBs, is known to cause permanent hearing damage at levels over 85 dB. The prevalence of hearing damage, and lack of protective measures available is remarkable, especially when it comes to “social noise exposure.” While regulations such as those drafted by NIOSH and the European Commission have been applied to occupational hearing safety for nearly thirty years, few limits and regulations are enforced for social and personal noise sources which can be equally bad or, in many cases nowadays, worse.

Tinnitus, a hissing or ringing sound in the ears, is another important condition associated with high-intensity noise exposure, and often accompanies NIHL. The American Hearing Research Foundation estimates that thirty six million Americans have some level of tinnitus and cases of tinnitus caused by social noise exposure—noise caused by everyday, social environmental factors—are on the rise.

The popular media has started to pick up on this: The New York Times recently featured an article and associated city map with damage hotspots such as restaurants, gyms, fitness classes, and bars, most reaching unsafe levels of 100 dB or more. This article was accompanied by a “sound tour” of New York City that measures average and continuous decibel levels in some of the cities popular locales. One outstanding example: Beaumarchais, a popular restaurant, had an average level of 104 dB, allowing for a safe exposure limit of roughly five minutes. The difference in standards between occupational and social environments is described in the article:

Urban noise—such as that from trains and public transport, traffic, airports, and even car parks—is coming under increased scrutiny, as well. The measurement of urban noise has led to both the European Environment Agency and hearing company Phonak publishing urban noise maps which highlight locations across the globe that feature dangerous noise levels.

Studies on transit systems in San Francisco and New York reveal that trains in the New York Subway and BART systems can easily produce 80 dB on average, with particularly bad lines or stations averaging up to as much as 96 dB.

Other common sources of noise with high intensity levels are:

City traffic (inside car)—85 dB

Subway train (200 feet away)—95 dB

Motorcycle (average)—100 dB

Gunshot—144-172 dB

Fitness club (spin class, peak)—99 dB

Music Concert/Festival—120 dB. Can peak at 140 dB

Night Club (peak in front of speakers)—115 dB

High sound pressure levels or a weighted measure over time so that the aggregate of 100 dBs (dBA?) over 15 minutes of exposure, can also cause similar injury. For each 3 dB increase in sound power level above 85 dBs it would be advantageous to reduce the exposure time limit by one half. For a sound power level of P.sub.i in dBs the maximum exposure time could be calculated as:

T.sub.i=8/log.sub.10.sup.−1((P.sub.i−85)/10) hours

or

T.sub.i=8/antilog.sub.10((P.sub.i−85)/10) hours.

If one were to measure the cumulative exposure at all levels above 85 dBs by recording the total time t.sub.i that the sound power level is in each range P.sub.i. then the cumulative exposure dose D relative to a maximum exposure limit of 100% is given by:

D=(t.sub.1/T.sub.1+t.sub.2/T.sub.2+ . . . +t.sub.n/T.sub.n)*100%.

By employing the above calculations, in conjunction with the exposure guidelines for hearing loss prevention released by Occupational health organizations in the EU, as well as OSHA and the National Institute for Occupational Safety and Health (NIOSH) in the USA (see below chart), one can readily see the pressing need for a device which can be used to protect the user's hearing while still permitting them to enjoy sound and event situation without being stigmatized as being an “old person” wearing a hearing aid.

TABLE
Sound intensity-exposure-damage relationship. Note that
for every 3 dB increase, the sound energy roughly doubles
(as the decibel scale is logarithmic), thereby halving
the amount of exposure time before damage.

| dB level | Exposure limit before damage occurs |
|---|---|
| 85 dB | 8 hours of exposure |
| 88 dB | 4 hours of exposure |
| 91 dB | 2 hours of exposure |
| 94 dB | 1 hour of exposure |
| 97 dB | 30 minutes of exposure |
| 100 dB | 15 minutes of exposure |
| 103 dB | ~7 minutes of exposure |
| 106 dB | ~3 minutes of exposure |

Source: http://www.cdc.gov/niosh/topics/noise/chart-lookatnoise.html (accessed Sep. 09, 2012)

The amount of otic injury and the number of younger people with such injury reveal one certain concept: social and environmental noise easily reaches levels that cause damage to hearing with many social settings, environments and spaces allowing unregulated decibel levels that cause damage if endured for only a few minutes. The National Institute of Health (www.nih.qov) and National Institute for Occupational Safety and Health (http://www.cdc.gov/niosh/98-126.html) recommend no more than 15 minutes of exposure to high sound power levels above 100 dBs and no more than 8 hours of exposure above 85 dBs. Despite these recommendations and the documented effect—which results from ignoring hearing health warnings that are becoming more and more prevalent—there is little effort being made to develop and implement a system, which detects the presence of hearing-damaging situations and protects the individual. Moreover, since the effect of noise is cumulative and there is a desensitizing element, which occurs when a person is subjected to hearing-damaging situations, there is a tendency to ignore the effect until it is too late and irreversible. Hearing loss, unlike that of loss of sight, cannot be fixed by something like Lasik surgery. It is permanent.

While there is currently technology, which serves to provide hearing aids or “corrective in-ear devices,” which are used after the damage has been done, there is little effort being expended to provide preventative in-ear devices, which are adaptable to current environmental conditions and yet permit the wearer to not be stigmatized as “needing a hearing aid”. Moreover, the few areas where it is normal to see hearing “protection” is in such fields as specialty products for musicians. Products from Custom Protect Ear, Etymotix, and Westone are all examples, but they are targeted at professionals, not average consumers. Recent trends in hearing protection have focused on “smart” or specific-purpose earplugs. These commonly feature either a specifically designed material compound that provides static but custom frequency attenuation (dampening), require audiologists and specific moldings, or contain receivers, reproducers, and digital signal processing units to dynamically shape received sounds according to certain EQ profiles.

A modern hearing aid can help to mitigate at least some of the problems associated with impaired hearing by amplifying ambient sound. A modern hearing aid can receive an input audio signal using an input converter. The audio input signal can in turn be converted into electrical input signals that are routed to a signal-processing unit for further processing and amplification. The further processing and amplification can be used to compensate for the individual loss of hearing of a hearing aid wearer. The signal-processing unit provides an electrical output signal, which is fed via an output converter to the wearer of the hearing aid so the wearer perceives the output signal as an acoustic signal. Earpieces which generate an acoustic output signal are usually used as output converters.

Every electronic hearing aid has at minimum a microphone, a loudspeaker (commonly called a receiver), a battery, and electronic circuitry. The electronic circuitry varies among devices, even if they are the same style. The circuitry falls into three categories based on the type of audio processing (Analog or Digital) and the type of control circuitry (Adjustable or Programmable). In one category, the audio circuit is analog having electronic components that can be adjusted. With these types of hearing aids, a hearing professional (such as an audiologist or certified technician) determines the gain and other specifications required for the wearer, and then adjusts the analog components either with small controls on the hearing aid itself or by having a laboratory build the hearing aid to meet those specifications. After the adjustment is completed, the resulting audio processing does not change any further, other than possibly overall loudness that the wearer adjusts with a volume control. This type of circuitry is generally the least flexible.

In another category, the audio circuit is analog but with additional electronic control circuitry that can be programmed, sometimes with more than one program. The electronic control circuitry can be fixed during manufacturing or in some cases, the hearing professional can use an external computer temporarily connected to the hearing aid to program the additional control circuitry. The wearer can change the program for different listening environments by pressing buttons either on the device itself or on a remote control or in some cases the additional control circuitry operates automatically. This type of circuitry is generally more flexible than simple adjustable controls.

In yet another category, both the audio circuit and the additional control circuits are fully digital in nature. The hearing professional programs the hearing aid with an external computer temporarily connected to the device and can adjust all processing characteristics on an individual basis. Fully digital hearing aids can be programmed with multiple programs that can be invoked by the wearer, or that operate automatically and adaptively. These programs reduce acoustic feedback (whistling), reduce background noise, detect and automatically accommodate different listening environments (loud vs. soft, speech vs. music, quiet vs. noisy, etc.), control additional components such as multiple microphones to improve spatial hearing, transpose frequencies (shift high frequencies that a wearer may not hear to lower frequency regions where hearing may be better), and implement many other features. In some embodiments, the hearing aid wearer has almost complete control over the settings of most, but not all, settings. For example, in order to prevent unintended harm to the wearer, certain settings (such as gain) can only be changed within a well-defined range. Other settings, such a frequency response, can have more latitude but any allowed changes will nonetheless be restricted in order to prevent any changes to the audio processing that may be harmful to the hearing aid wearer.

Fully digital circuitry can also include wireless hearing aids that allow control over wireless transmission capability for both the audio and the control circuitry. Control signals in a hearing aid on one ear can be sent wirelessly to the control circuitry in the hearing aid on the opposite ear to ensure that the audio in both ears is either matched directly or that the audio contains intentional differences that mimic the differences in normal binaural hearing to preserve spatial hearing ability. Audio signals can be sent wirelessly to and from external devices through a separate module, often a small device worn like a pendant and commonly called a “streamer” that allows wireless connection to yet other external devices. In those embodiments where additional computational resources or sensor resources are required, the external devices can take the form of a portable computing device along the lines of a smart phone, mobile applications, wristband, tablet device, and/or portable media player.

Programmable hearing aids that allow a user to adjust the hearing aid response to their own preference have been recently made available at reasonable cost. Using the programmable hearing aid, for example, the frequency response of the hearing aid can be adjusted by the consumer in order to improve the overall user experience by accentuating certain frequencies or range of frequencies. In addition to programmable hearing aids, wireless hearing aids have been developed. For example, for a hearing impaired consumer using two hearing aids, an adjustment to one of the two hearing aids can be transmitted to the other hearing aid such that pressing one hearing aid's program button simultaneously changes the corresponding settings on the other hearing aid such that both hearing aids change settings simultaneously.

Therefore, with the advent of programmable hearing devices whose signal processing can at least be partially modified, what is desired is providing a hearing device user the ability to modify the audio processing of the programmable hearing device in the context for which the hearing device will be used.

Wireless connection to external devices such as TVs, phones, and stereos;

Speech processing and clarifying;

Music/media enhancement profiles and auto-detection;

Noise reduction and adaptive filtering;

Rechargeable batteries; and,

Adaptive or tracking dual locational microphones.

While the list above demonstrates a number of attractive and important technological features of new hearing aids which permit individuals with hearing impairments to enjoy a wide range of auditory stimulae, there has not been an effort to adapt the hearing aid technology to engage those without current otic issues in order to prevent them from becoming impaired. Hearing aids today permit, among other things, the following connectivity and auditory enhancements:

While current “corrective” hearing aids today generally seek to provide the wearer the ability to hear what they might not otherwise be able to hear, the problem encountered by a “protective” hearing aid is that a wearer will want to experience fully whatever he/she is listening to at a safe level but not lose any of the nuances throughout the bandwidth of whatever he/she is listening to. Moreover they want to know how long they have to enjoy something at a possible level which might be damaging in order to permit them to make the conscious decision as to the matter and time which they will have a given exposure to a decibel level.

The sensitivity of the human ear varies with both frequency and level, a fact well documented in the psychoacoustics literature. One of the results is that the perceived spectrum or timbre of a given sound varies with the acoustic level at which the sound is heard. For example, for a sound containing low, middle and high frequencies, the perceived relative proportions of such frequency components change with the overall loudness of the sound; when it is quiet the low and high frequency components sound quieter relative to the middle frequencies than they sound when it is loud. This phenomenon is well known. Thus, the lower sensitivity of the ear at the frequency extremes is often compensated for by in turning up the sound and endangering the ear. Concomitantly, in order to provide accurate sound which is acceptable to a “protective” hearing device wearer, it is necessary to ensure that the spectral range remains such that each frequency element does not result in a distortion of the overall perceived signal on the auditory system and cause the wearer to either increase “loudness” or otherwise diminish the protective aspect of the system.

### SUMMARY OF THE INVENTION

It is an object of this invention to provide an in-ear hearing device which permits both automatic and regulated adaptation to protect a user's listening and audio experience while protecting the wearer from unwanted decibel levels that might otherwise cause damage to their hearing.

It is a further object to this invention to provide a system, either alone or in connection with an in-ear hearing device, which incorporates a sensor and count down system to indicate the current decibel level and associated amount of time an individual has in a given environment prior to causing permanent hearing damage and correlates that to one or more databases which contain information to permit the selection of decibel levels for their device/system which will minimize hearing loss and damage to the auditory system and avoidance of areas of potential high decibel levels.

It is yet a further object of this invention to provide decibel correction, augmentation and connectivity between the hearing device and other sound and media sources to permit the enhancement of the auditory experience and provide the ability of the wearer to control that experience.

It is yet a further object of this invention to permit the decibel correction and detection to occur either in connection with a related personal electronic device, mobile application, wristband, smart-phone or similar system, a programmable set of criteria associated with the hearing aid or by way of a dedicated control system each of which can modulate and regulate the frequencies and decibel level delivered to and auditory experience of the user of the personal electronic device and the hearing device.

It is yet a further object of this invention to permit the wearer to create a hotspot map, through use of digital mediums such as a mobile applications, which would delineate the various hearing damage hotspots where the wearer and others within his social network would incur hearing loss as a result of high decibel levels.

It is another object of this invention to permit the user of the personal electronic device and others to share the hearing damage location information with one another and thereby avoid said locations, which might adversely affect their hearing

It is a further object of this invention to permit the creation of a hearing-loss prevention based social network, either with or without hearing devices, by carrying on a communication through a computing device between participants each with personal electronic device and with or without a hearing device. A first participant can provide identifying information and suggest decibel corrective action to other members of the social network, who can then implement that action and provide it to others within the social network. The decibel corrective action can illustratively be avoidance, rapid departure or modulation of sound received through a hearing device.

It is a further aspect of this invention to provide a method for updating hearing-damaging locations and events by to other members of the protective hearing health/device social network by communicating with an electronic device which and undertaking the following steps: identifying a hearing-damaging situation, providing an adaptive and corrective setting corresponding to the updated information which is being received by the first member of the social network, the adaptation corresponding to the updated audio processing of information regarding the hearing-damaging event or location, requesting a review of the information and corrective action, receiving the review of the information when it is available, using the received hearing aid review information to update the audio processing and protective aspects of the programmable hearing aid, and processing ambient sound received at the programmable hearing aid device in accordance with the received and reviewed information.

It is a further aspect of this invention to provide a non-transitory computer readable medium for storing computer code executable by a processor incorporated in an electronic device for updating audio processing of a programmable hearing device in communication with the electronic device and updating information relative to hearing-damaging situations. The computer readable medium includes at least computer code for identifying a hearing-damaging situation, providing an adaptive and corrective setting, or alternative location or routing corresponding to the updated information which is being received by the first member of the social network, the adaptation corresponding to the updated audio processing of information regarding the hearing-damaging event or location, processing a review of the information and corrective action, receiving the review of the information and corrective action and using the received hearing device review information to update the audio processing and protective aspects of the programmable hearing device or the member routing, and processing ambient sound received at the programmable hearing device in accordance with the received and reviewed information.

It is yet a further aspect of this invention to provide a predictive and a cautionary data stream to the personal electronic device user and/or hearing device wearer to indicate the amount of time the wearer has at any specific decibel level until they incur hearing damage, thus permitting them to either remove themselves from the hearing damaging situation, implement corrective hearing device/health action or take other corrective actions to reduce the effect of the situation. This information can be disseminated by the mobile applications and will include a countdown function based on standards of hearing damage exposure data.

It is another aspect of this invention to generate a differential hearing loss calculation to permit the hearing aid wearer to ascertain the immediate benefit of employing the decibel reducing and protecting devices by delineating the affected additional time the hearing aid wearer can remain within the hearing damaging situation without adversely affecting their auditory system.

Other aspects and advantages will become apparent from the following detailed description taken in conjunction with the accompanying drawings which illustrate, by way of example, the principles of the invention.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 shows a representative hearing device in accordance with the described embodiments.

FIG. 2 is a flowchart detailing a process in accordance with the described embodiments.

FIG. 3 is a flowchart detailing a process for employing an external processor in accordance with the described embodiments.

FIG. 4 is a representative computing system and processor in accordance with the described embodiments.

FIG. 5 is a representative computing system and processor for employing an external processor in accordance with the described embodiments.

FIG. 6 is a representative aspect of the computing system and processor in accordance with the described embodiments.

### DETAILED DESCRIPTION OF THE DESCRIBED EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

In the discussion that follows, terms such as hearing device system may be employed to refer to sample implementations of the present invention. However, no particular limitation should be inferred in scope or applicability of the invention from the use of this term.

Certain terminology may be used in the following description for convenience only and is not limiting. The words “lower” and “upper” and “top” and “bottom” designate directions only and are used in conjunction with such drawings as may be included to fully describe the invention. The terminology includes the above words specifically mentioned, derivatives thereof and words of similar import.

Where a term is provided in the singular, the inventors also contemplate aspects of the invention described by the plural of that term. As used in this specification and in any claims, the singular forms “a”, “an”, and “the” include plural references unless the context clearly dictates otherwise, e.g. “a derivative work”. Thus, for example, a reference to “a method” includes one or more methods, and/or steps of the type described therein and/or which will become apparent to those persons skilled in the art upon reading this disclosure.

Unless defined otherwise, all technical, legal, copyright related and scientific terms used herein have the same meaning or meanings as commonly understood by one of ordinary skill in the art to which this invention belongs. Although any methods and materials similar or equivalent to those described herein can be used in the practice or testing of the present invention, the preferred methods, constructs and materials are described herein. All publications mentioned herein, whether in the text or by way of numerical designation, are incorporated herein by reference in their entirety. Where there are discrepancies in terms and definitions used by reference, the terms used in this application shall have the definitions given herein.

The term “variation” of an invention includes any embodiment of the invention, unless expressly specified otherwise.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise.

The terms “a”, “an” and “the” mean “one or more”, unless expressly specified otherwise. The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a hearing-damaging location” describes both “the data represents only the hearing-damaging location” and “the data represents a hearing-damaging location and the data also represents something else, such as an event or occurrence”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, and/or “e.g.” and like terms means “for example”, and thus does not limit the term or phrase it explains. For example, in the sentence “the microprocessor sends data (e.g., instructions, a data structure)”, the term “e.g.” explains that “instructions” are an example of “data” that the system may send, and also explains that “a data structure” is an example of “data” that the system may send. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in the Figures may be provided by a single shared processor or multiple processors. Use of the term “processor” should not be construed to refer exclusively to hardware capable of executing software.

Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

A “processor” includes one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device and includes non-transitory computer-readable medium. Such a medium may take many forms, including but not limited to, non-volatile media, volatile media, and transmission media.

This detailed description makes reference to certain exemplary embodiments of the invention and various aspect of the invention. Other embodiments may be employed, and aspects described or not described, and structural and electrical changes may be made without departing from the spirit or scope of the present invention.

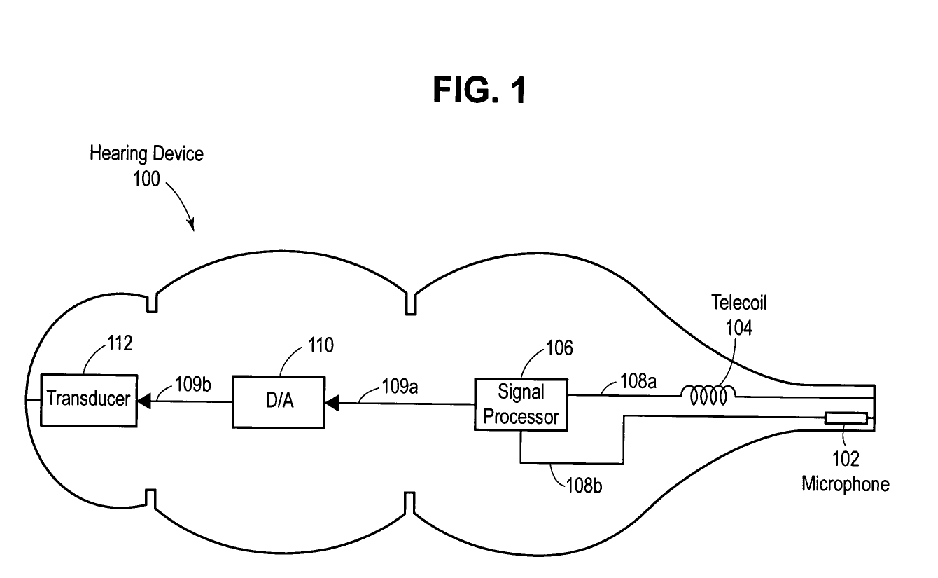

FIG. 1 is a block schematic showing a hearing device 100 in accordance with the described embodiments. Hearing aid 100 can include at least audio sensor 102 arranged to detect acoustic energy that can take the form of sound. The hearing aid 100 may also employ a tele-coil 104 to similarly detect acoustic energy that can take the form of sound. In one embodiment, audio sensor 102 can take the form of (one or more) microphone 102 connected to an input node of audio signal processing circuitry 106. Similarly tele-coil 104 can be connected to an input n is ode of the audio signal processing circuitry 106. Microphone 102 can mechanically respond to sound waves impinging on the surface of a membrane (not shown). The vibrating membrane can interact with a transducer (not shown) to create electrical signal 108 that is analogous (i.e., the analog) to the detected sound waves. Alternatively, the tele-coil 104 can provide an analog signal to an input node of audio signal processing circuitry 106.

The electrical analog signal 108 can be passed to audio processing circuitry 106 for processing. While the audio processing circuitry 106 can be totally analog in nature, in other embodiments, the audio processing circuitry 104 can have some components that are analog while other components are digital. With that explanation and without loss of generality, the audio processing circuitry 108, will, for purpose of simplicity, be considered as being fully digital in nature. The digital audio processing circuitry 106 can include analog to digital (A/D) converter unit (not shown) arranged to receive analog signal 108 generated by microphone 102 and convert the analog signal 108 into a digital signal 109 using any suitable digitization process.

An output node of the A/D converter unit can be connected to a digital signal processor 106. The digital signal processor 106 can include at least additional signal processing circuits (not shown) for filtering, compressing, modulating, decreasing and/or amplifying input digital signal 109 to form output digital signal 109A at an output node of digital signal processor 109 that can, in turn, be connected to an input node of a digital/analog (D/A) converter 110. The digital signal processor 106 can also include additional signal processing circuits which can compare the input digital signal 109 to other data, including its magnitude as a function of time, or as a function of other criteria and adapt, modify, decrease or otherwise alter the input digital signal 109 to form output digital signal 109A

D/A converter 110 can convert digital signal 109A into a corresponding analog signal 109B at an output node of D/A converter (not shown) that can be connected to and be used to drive output transducer 110. It should be noted, however, that in an alternative embodiment, digital signal processor 109 can be configured in such a way to drive output transducer 110 directly without requiring D/A converter

It should also be noted that output 110 can take many forms depending upon the nature of hearing aid 100. For example, in one embodiment, output 110 can take the form of an acoustic transducer arranged to provide acoustic output in the form of sound waves. The acoustic output can then be transmitted in a conventional manner to the hearing aid user's auditory system.

In one embodiment, digital signal processor 106 can be programmable by which it is meant that the audio processing carried out by digital signal processor 106 can be widely varied. For example, digital signal processor 106 can be programmed according to a decibel level profile that can include a plurality of settings each of which can alter a corresponding audio processing operation. For example, the settings can include various decibel level curves (along the lines of a buffer or data storage system), comparators, controls, filtering such as notch, clipping or band pass filtering and the like. Moreover, the digital signal processor 106 can incorporate a set of rules which relate to hearing-damaging situations and locations. In this way, hearing aid 100 can adapt its signal processing to a wide number of variables such as the environmental (i.e., ambient) noise level, user provided changes to parameters and so on.

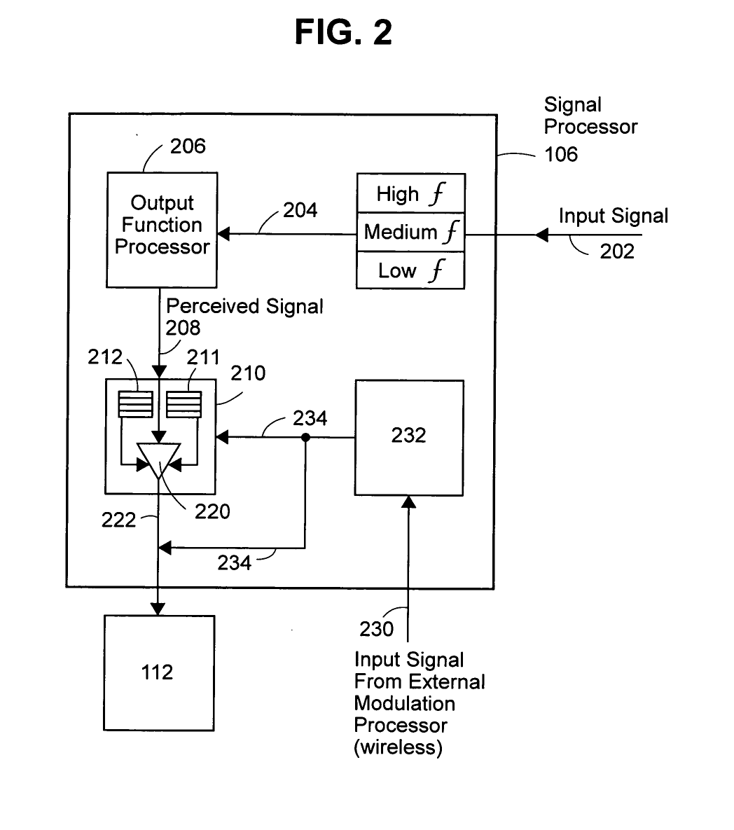

FIG. 2 is a flowchart detailing a device in accordance with the described embodiments. An input signal 202 is passed to the frequency band analyzer circuitry 203 of the digital signal processor 106. The frequency band analyzer circuitry 203 may permit the determination of the bandwidths and frequency distribution of the input signal into a distributive function signal 204 representative of the high, medium and low frequencies. The distributed function signal 204 is analyzed by an out put function processor 206 which determines the decibel level and generates a perceived signal 208. The perceived signal 208 is transmitted to an internal modulation processor 210. The internal modulation processor 210 may incorporate a preprogrammed data array with decibel level indicators and a set of rules as to the effect of each of the decibel level indicators.

The perceived signal 208 is processed by the internal modulation processor 210 to determine whether corresponds to any of the decibel level indicators and, if so, whether to apply one or more of the rules to the perceived signal 208. By way of example, the internal modulation processor 210 may incorporate a comparator circuit 220 which processes the perceived signal 208 and compares it to the array of decibel level indicators to derive a differential between the perceived signal 208 and the closest decibel level indicator. Once the comparator circuit 220 has derived a differential, it can, using a lookup table, determine the rule which should be applied in order to modulate the perceived signal 208 and bring it within the confines of the rule

If the perceived signal 208 is modulated in accordance with one of the rules, a output audio signal 222 is delivered via the comparator circuit 220 to the transmitter 110. Alternatively if the perceived signal 208 is not modulated then the input signal 202 may be directly delivered to the transmitter 110. As can be appreciated by the above illustrative example, the internal modulation processor 208 can provide automatic auditory protection to the hearing aid where in the event of a determination of the presence of a hearing-damaging situation. The internal modulation processor may also perform its modulation as a function of decibels per unit time in order to provide a running aggregate for protective purposes. Alternatively it can have an acceleration function analyzer to determine the presence of a rapid increment of decibels analogous to a instantaneous peak in sound, such as a siren or other sharp and immediate noise

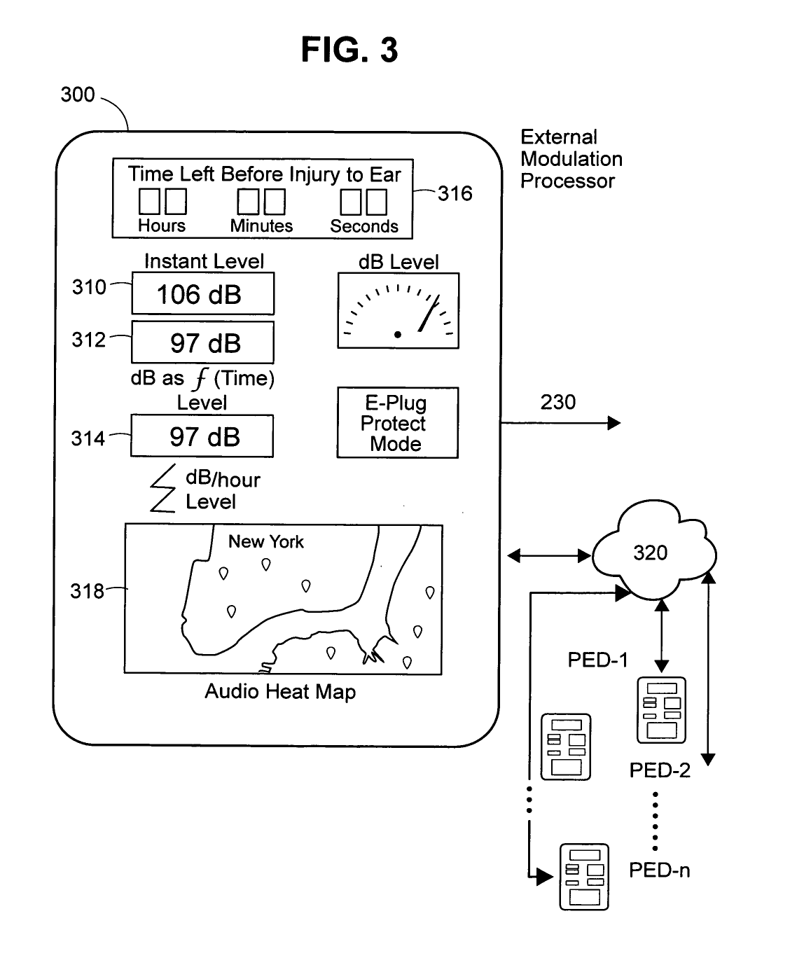

FIG. 3 is a flowchart detailing a process for employing an external processor in accordance with the described embodiments. While the earlier illustrative examples have the described the system in relationship to an internal modulation processor 208, the ability of hearing aid 100 to be externally controlled is illustratively shown in FIG. 3 where, by way of example, a portable electronic device 300, such as an iPhone®, is incorporated in the modulation process to either override the internal modulation processor at 208 or to augment its function. The portable electronic device 300 has a microprocessor (not shown) and a receiver 302 capable of responding to and processing and input signal 304 representative of the ambient noise and any hearing damaging situations. The receiver 302 processes the input signal 304 and generates an output function 306 which is representative of the input signal 304. The output function 306 may be displayed on the portable electronic device 300 as an absolute value in terms of the decibel level or in some other suitable fashion so as to provide the hearing device user with an indication of the noise level at the particular location at that particular time.

As a further part of the informational display on the portable electronic device or mobile application operated device 300, a countdown clock 310 may be incorporated to provide the hearing device wearer with data as to the otic effect of the particular ambient situation in which the hearing device wearer currently finds himself/herself. Thus by way of example the countdown clock may indicate the number of minutes which the person can remain at that location before there is damage to their auditory system and simultaneously or alternatively provide information as to the differential time which a person can remain if the hearing device which they are wearing is modulating the input sound in accordance with decibel array employed by the internal modulation processor 208. Thus a person can see that if they were to remain within an area with noise having a decibel level of 106 dB, their hearing would be affected within approximately 3 minutes whereas by having the hearing aid they are able to remain within the area for an hour since the modulation has been reduced, illustratively, to 94 dB.

FIG. 3 alternatively illustrates the use of the portable electronic device/mobile application operated system 300 as an informational tool which, even absent the use of a hearing aid to 100 in connection therewith, can serve to protect the hearing of an individual in the presence of hearing damaging situations. While ideally an individual would wear a hearing device, which would detect and protect the individual from otic damage due to external noise, people may choose not to wear such a device and rather avoid hearing damaging situations or be in their presence for the smallest amount of time possible. In that regard the instant invention permits that advantageous result whether or not the individual is using concurrently a protective hearing device. Thus, the portable electronic device 300 and, as described above, determine the decibel level through which an individual is currently passing and provide both an instantaneous measure and a measure as a function of time to show cumulative decibel impingement on the auditory system, and the user can act accordingly, or can have the system automatically respond and provide corrective and modulated input signals to the protective hearing device.

By providing that information to the individual the individual would immediately know that he was in a safe zone of 80-85 dB or less, a potentially hazardous zone, where prolonged visitation could result in hearing damage (eg. 91 to 97 dB) or an extremely hazardous zone where even a short amount of exposure would result in permanent hearing damage (eg. 106+ dB). Armed with that information, the individual could immediately leave the zone or take other action to minimize any auditory damage. Additionally, the individual would be provided with a countdown clock, which would advise them of the amount of time they had in order to leave the adverse area in order to protect their hearing. Ideally the individual would have a set of easily accessible, protective hearing devices, which, upon determining that there was a dangerous auditory area they could insert to modulate the decibel level and permit them to remain within the adverse area for a longer period, extending the amount of time they could enjoy the space they were currently in. One representative standard for calibrating the countdown clock would be the NIOSH standards. Those standards would be implemented as a data buffer, which would be triggered on determination of an ambient noise thus by way of example if the ambient noise was below 80 dB it would indicate that a person could remain within the area for up to eight hours whereas if it was 106 dB they could only remain for a countdown period of three minutes or less.

As is further exemplified in FIG. 3, the portable electronic device 300 can, illustratively, have a differential clock display which would provide a night a graphic or digital form information as to the amount of time individual could otherwise remain in the area if the decibel level were reduced to an acceptable level by employing appropriate hearing device 100 with sound modulation. With the portable electronic device 300 serving as an informational tool, the information can be employed both to provide the individual using the portable electronic device 300 with an auditory “adverse level” data map and to permit the sharing of that information with other individuals within a social network. The display may be programmed to provide decibel peaks and valleys on a mapping system, such as Google Maps®, and provide hotspots designated as red where the decibel level is over 100 dB100 and green where the decibel level is 85 dB or below. By way of example each individual within the social network could augment and share the adverse level data map with others so that they could each avoid the areas having high noise and plan that into their respective routing and travel locations. This could be used within a specific location (i.e. an NFL stadium) so that users could identify a hallway, stairwell, etc. where they could rest their ears for a given period of time before going back out into the crowd.

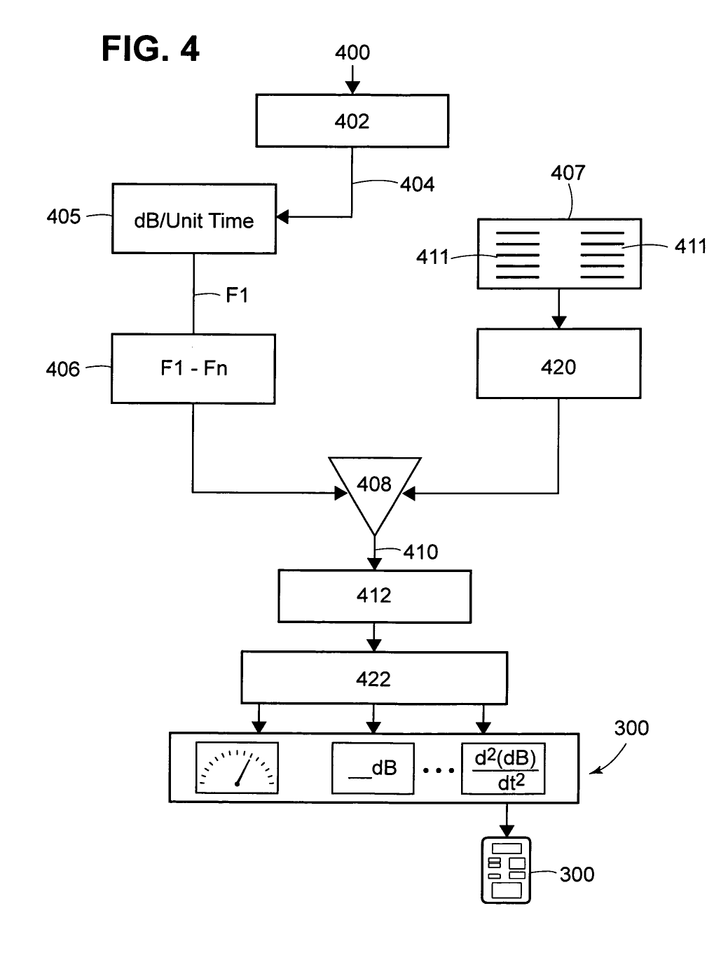

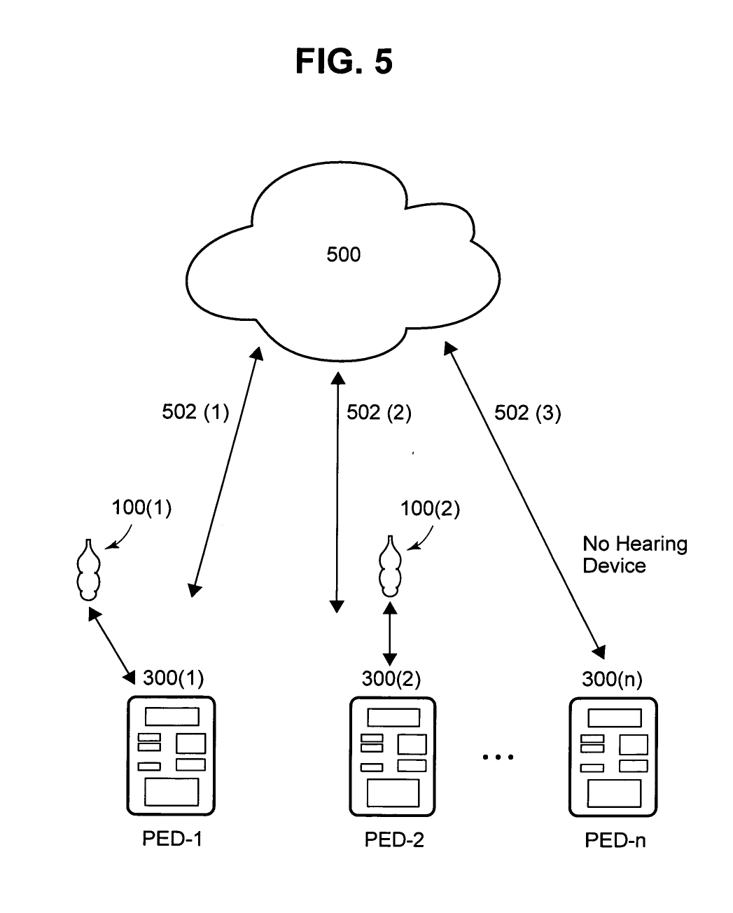

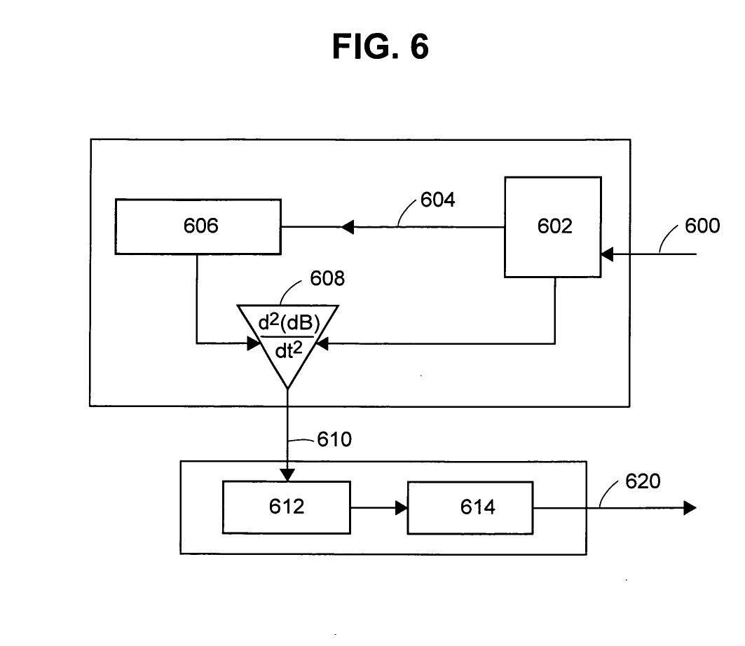

FIGS. 4, 5 and 6 are alternative representative computing system(s) and processors in accordance with the described embodiments. Input audio signal 400 is detected by receiver 402, which generates an electrical signal 404 representative of the input audio signal 400. The electrical signal 404 is processed to determine the decibel level per unit of time to arrive at an aggregate adverse auditory function F1. The adverse auditory function F1 is stored in a buffer 406. The processor has stored data representative of indicative decibel levels per unit of time. The computer system reads the indicative decibel levels and reads the adverse auditory function F1 by means a comparator circuit 408. An output signal 410 of the comparator circuit 408 is processed and delivered to a differential magnitude buffer 412. Successive output signals 410 are maintained in the differential magnitude buffer 412 and a push down lists. The differential magnitude buffer 412 is capable of permitting the processing the successive output signals 410 in a variety of manners. The differential magnitude buffer 412 may provide successive output signals to a selector/attenuator microprocessor 420 to permit it to arrive at an average calculation over a period of time of the amount of adverse auditory effect any given area.

Alternatively, the differential magnitude buffer 412 may deliver one or more peak readings from the output signals 410 to the selector/attenuator microprocessor 420 to permit it to arrive at a determination of the amount of an instantaneous adverse auditory effect in a given area. Additionally the differential magnitude buffer 412 may deliver successive output signals 410 to the selector/attenuator microprocessor 420 to permit it to take the second derivative of successive output signals 410 to determine whether an individual is proceeding into an area of adverse auditory effect.

In each instance the output of the selector/attenuator microprocessor 420 may be displayed on the portable electronic device 300 and, in the event that the individual employing the portable electronic device 300 has a hearing aid 100 the output of the selector/attenuator microprocessor 420 may advantageously be employed to modify the input audio which the individual will ultimately receive through the transmitter.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. The computer readable medium can also be distributed over network-coupled computer systems so that the computer readable code is stored and executed in a distributed fashion.

The many features and advantages of the present invention are apparent from the written description and thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A mobile system for providing auditory protection comprising:
a. an electronic device having a graphical display to present at least a portion of a graphical user interface;
b. a computing device including non-transitory computer readable medium for storing computer code executable by a processor incorporated in an electronic device for updating audio processing of an auditory representative input signal in communication with the electronic device, comprising: computer code for identifying an auditory representative input signal; computer code for requesting a review of the identified auditory representative input signal; computer code for receiving the review of the requested auditory representative input signal; computer code for comparing the requested auditory representative input signal with a predetermined compilation of potential input signals; computer code for displaying the result of the comparison; and computer code for processing ambient sound in accordance with the updated audio processing.

2. The computer readable medium as recited in claim 1, wherein the electronic device is a portable communication device.

3. The mobile system of claim 1, wherein the portable communication device further comprises:
a. a processor to sense an ambient sound representative input signal;
b. an application to control the processor; and,
c. communication mean to deliver the sensed ambient sound representative signal to a computing device.

4. The mobile system of claim 1 further comprising:
a. an in-ear hearing device;
b. processor means to derive a modulation instruction which is a function of the sensed ambient input signal; and,
c. transmission means to transmit the modulation instructions to the in-ear hearing device to maintain a determined input signal level.

5. A method for providing protective signal data to a mobile device user comprising:
a. receiving at least one auditory representative input signal;
b. processing the auditory representative input signal to evaluate its decibel level;
c. graphically displaying a representation of the auditory representative input signal on at least a portion of a graphical user interface;
d. processing non-transitory computer readable, stored computer code executable by a processor incorporated in a computing device to compare the auditory representative input signal with at least one stored signal representative of an acceptable decibel level;
e. communicating with the mobile device user decibel level of the auditory representative input signal;
e. processing the two signals to derive the difference in the two signals; and,
f. communicating to the mobile device user the difference in the two signals.

6. The method of claim 5 further comprising the mobile device user:
a. wearing an in-ear hearing device capable of attenuating and otherwise modifying the auditory representative input signal.

7. The method of claim 6 further comprising:
a. processing the auditory representative input signal to derive a modulation signal to reduce the decibel level of the auditory representative input signal to an acceptable decibel level;
b. transmitting the modulation signal to the in-ear hearing device being worn by the mobile device user.
